(19) United States
(12) Patent Application Publication
(10) Pub. No.: US 2026/0368135 A1
(43) Pub. Date: Nov. 19, 2026

(54) UPDATING EMBEDDINGS FOR LARGE FILES

(71) Applicant: International Business Machines Corporation, Armonk, NY (US)

(72) Inventors: Paul Henri Muench, San Jose, CA (US); Brian D. Hatfield, Tucson, AZ (US)

(21) Appl. No.: 19/212,417

(22) Filed: May 19, 2025

(51) Int. Cl. G06F 16/13; G06F 16/16; G06F 16/174

(52) U.S. Cl. CPC G06F 16/137; G06F 16/164; G06F 16/1752

(57) ABSTRACT

A method, according to one approach, includes: dividing a large file into segments and generating hashes for the segments. A desired number of chunks are created by chunking the large file. Moreover, embeddings are generated for the respective chunks. In response to identifying one or more changes to the large file: the chunks and the embeddings are automatically updated. Furthermore, only the one or more changes are processed. Metadata for mapping file offsets to the updated chunks is also maintained.

### BACKGROUND

The present invention relates to data processing, and more specifically, this invention relates to maintaining embeddings.

Increased data production has amplified the overhead associated with data management and processing. While artificial intelligence (AI) has been developed in an attempt to combat this rise in processing overhead, advancements in AI have introduced their own challenges. For instance, as the amount of data AI based models are able to ingest increases, the storage footprint associated with these models increases as well. This in turn impacts vector storage and other aspects of maintaining the data accessed and/or referenced by the AI based models. As the amount of data that is ingested increases, the costs associated with memory and compute consumed also increases.

AI applications involve the use of embeddings. Embeddings are numerical representations of data, e.g., such as words, sentences, images, users, etc., that capture their semantic meaning or characteristics in a vector. Embeddings thereby allow for complex, high-dimensional data to be transformed into a more manageable and meaningful form for machine learning models to process. While embeddings are particularly valuable for AI applications, calculating embeddings is expensive in time and compute resources. Accordingly, a need exists for a more efficient process of maintaining accurate embeddings for data in a system.

### SUMMARY

A method, according to one approach, includes: dividing a large file into segments and generating hashes for the segments. A desired number of chunks are created by chunking the large file. Moreover, embeddings are generated for the respective chunks. In response to identifying one or more changes to the large file: the chunks and the embeddings are automatically updated. Furthermore, only the one or more changes are processed. Metadata for mapping file offsets to the updated chunks is also maintained.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of steps for one or more of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for improving the efficiency by which embeddings may be updated. Operations in method 300 may thereby involve eliminating duplicate calculations of embeddings for AI inferencing and training. This desirably allows for approaches herein to reduce latency as well as resource (e.g., compute) consumption, particularly for large files. For instance, only data that has been identified as being modified may result in new embeddings being calculated, while data that has only been moved or copied may reuse embeddings that have already been calculated, thereby reducing compute consumption and latency, e.g., as will be described in further detail below.

In one general approach, a method includes: dividing a large file into segments and generating hashes for the segments. A desired number of chunks are created by chunking the large file. Moreover, embeddings are generated for the respective chunks. In response to identifying one or more changes to the large file: the chunks and the embeddings are automatically updated. Furthermore, only the one or more changes are processed. Metadata for mapping file offsets to the updated chunks is also maintained.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved embedding code in block 150 for improving the efficiency by which embeddings may be updated. Operations in method 300 may thereby involve eliminating duplicate calculations of embeddings for AI inferencing and training. This desirably allows for approaches herein to reduce latency as well as resource (e.g., compute) consumption, particularly for large files. For instance, only data that has been identified as being modified may result in new embeddings being calculated, while data that has only been moved or copied may reuse embeddings that have already been calculated, thereby reducing compute consumption and latency, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

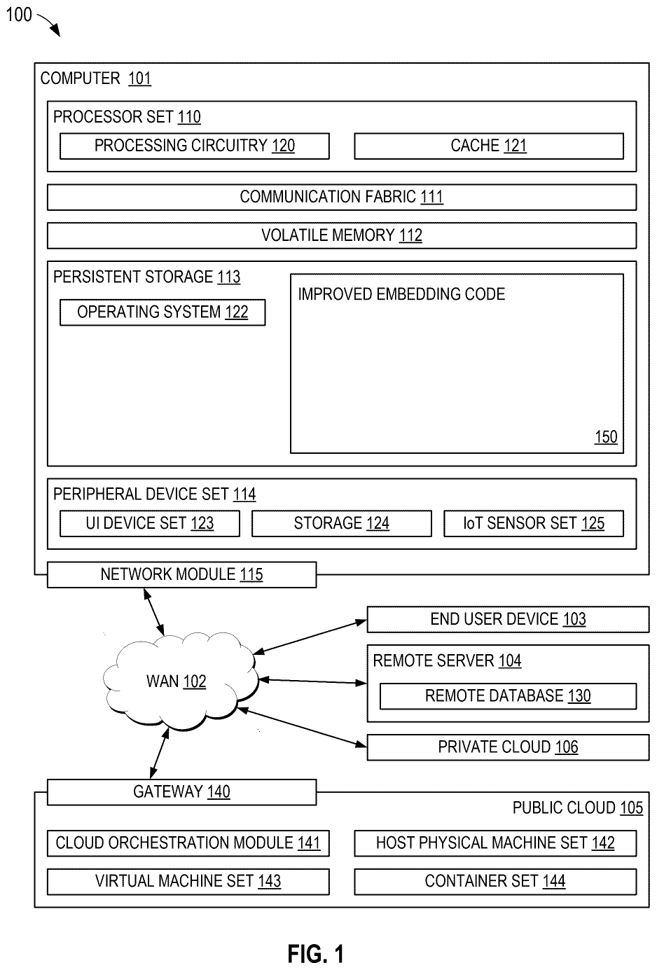

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By “integrated with,” what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, increased data production has amplified the overhead associated with data management and processing. While AI has been developed in an attempt to combat this rise in processing overhead, advancements in AI have introduced their own set of issues. For instance, conventional products have experienced impedance issues with respect to the amount of data AI based models are able to ingest compared to the associated storage demand. These conventional products have thereby been unable to operate and maintain data global signature indexes in a cost-effective manner. As the amount of data that is ingested increases, the costs associated with memory and compute consumption significantly increase.

AI applications involve the use of embeddings. Embeddings are numerical representations of data, e.g., such as words, sentences, images, users, etc., that capture their semantic meaning or characteristics in a vector. Embeddings thereby allow for complex, high-dimensional data to be transformed into a more manageable and meaningful form for machine learning models to process. While embeddings are particularly valuable for AI applications, calculating embeddings is expensive in time and compute resources.

According to a non-limiting example, RAG is implemented in some AI based models in an attempt to increase the accuracy with which queries may be answered (e.g., solved). The basic concept involves semantically comparing LLM queries to a base of domain knowledge, and enhancing the LLM queries with domain specific knowledge and instructions. Conventional techniques for performing semantic comparing involves combining embeddings of the LLM queries and domain knowledge. However, these conventional techniques call for the embeddings and related information to be repeatedly updated regardless of what data changes have occurred, if any, which has introduced significant inefficiencies. For instance, calculating embeddings in this manner is resource intensive both in time and GPU throughput.

Conventional inferencing applications are not capable of tracking data changes and therefore are simply unable to address these significant inefficiencies. This problem is also becoming worse over time as the amount of data being stored and managed can be in the petabytes or even higher, translating to weeks of time and GPU resources that are unnecessarily consumed.

In sharp contrast to these conventional shortcomings, approaches herein are able to improve the efficiency by which embeddings may be updated. This desirably allows for approaches herein to reduce latency as well as resource (e.g., compute) consumption, particularly for large files. For instance, embeddings may be generated from data sets within storage abstractions like files, objects, etc. Storage systems may thereby be modified to monitor and report any changes that occur at the abstraction (e.g., file) granularity. Calculating embeddings based on changes to an abstraction (e.g., file) can eliminate calculating embeddings for abstractions (e.g., files) that have not changed. Again, conventional systems are unable to monitor and report the changes that occur within an abstraction (e.g., file), let alone with any accuracy. This lack of monitoring becomes particularly troublesome when many small changes are made to a large number of abstractions (e.g., files) within the embedding data set. As alluded to above, this situation translates to conventional systems calculating embeddings for all the content in all changed files rather than calculating embeddings for just the changed content. Approaches herein overcome this limitation by introducing added granularity, e.g., as will be described in further detail below.

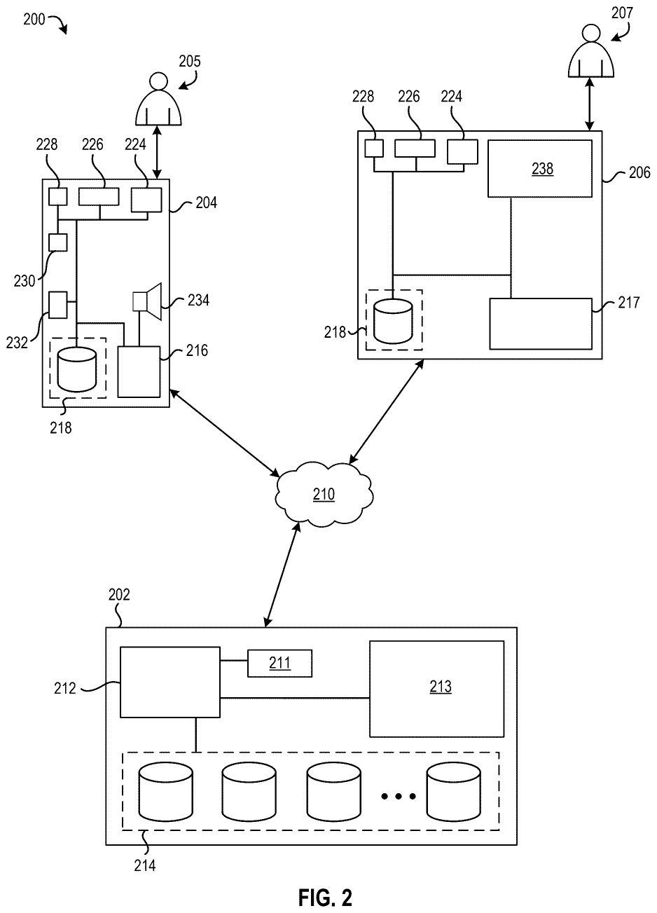

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting. For instance, while users and administrators may be described as being individuals in various implementations herein, a user and/or an administrator may be an application, an organization, a preset process, one or more AI based applications and/or models automatically running in the system, etc. The use of “data,” “files,” “metadata,” and “information” herein are in no way intended to be limiting either, and may include any desired type of details, e.g., depending on the type of operating system implemented on the user device 204, edge node 206, and/or central server 202. For instance, depending on the approach a file and/or chunks (e.g., portions) thereof as used herein may include text, stationary image based information (e.g., pixel outputs), motion based image information (e.g., video clips), etc. Files and/or chunks as used herein may thereby be of any desired size. Moreover, files and/or chunks in a given system may be of different sizes or the same size as each other depending on the approach. “Data” as used herein may also include files and/or objects that are of any desired size and which may be located in one or more data storage systems depending on the approach, e.g., as would be appreciated by one skilled in the art after reading the present description.

With continued reference to FIG. 2, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 and/or processor 212 are able to train one or more AI based models. For instance, AI model(s) may be trained in some approaches to monitor files and determine whether any changes are made to the files. Moreover, in response to identifying one or more changes to the files, AI based models herein are able to automatically generate updated information only for the changes that have been identified. For example, AI based models may selectively only recalculate embeddings for chunks that are identified as having changed, thereby reducing latency and resource consumption to maintain system operation. These AI based models are thereby able to eliminate duplicate calculations of embeddings for AI inferencing and training, thereby significantly reducing computational overhead consumed by processing incoming data operations.

As noted above, conventional products continually reprocess all data regardless of whether data changes have actually occurred, which has introduced significant inefficiencies. For instance, calculating embeddings in this conventional manner is resource intensive both in time and GPU throughput. However, conventional applications are simply incapable of tracking specific data changes or data deduplications, and are therefore fundamentally unable to address these significant run-time inefficiencies.

Approaches herein are again able to overcome these significant conventional shortcomings by enabling systems to identify changes that occur to data therein (e.g., in response to received data operations) and focus system resources on processing only the data that has changed. Meanwhile, data that has not changed (e.g., data known by the system) is intentionally not processed, but rather simply correlated with known embeddings, hash values, metadata, etc., that already exist in a global signature index. In other words, unchanged parts of the large file are prevented from being processed. For example, portions of a dataset that has been generated at, received at, stored at, identified at, etc. the edge node 206 may be sent to the central server 202. According to an example, the central server 202 may manage a global signature index having vectors and pointers correlated with the different data chunks that are received and stored therein. Data chunks already stored and represented in the global signature index (also referred to herein as a “vector database”) that are determined as matching updated data chunks after some time has passed may thereby be used to avoid performing duplicate calculations of embeddings for AI inferencing and training, e.g., as will be described in further detail below.

In some approaches, AI module 213 may implement prompt tuning to achieve this functionality, more specifically multi-prompt tuning (MPT). With respect to the present description, “prompt tuning” refers to the process of adapting a base pretrained model to each desired task via conditioning on learned prompt vectors. For instance, prompt tuning may be used to efficiently adapt LLMs to multiple downstream tasks. It should also be noted that “MPT” refers to a process, which initially includes learning a single transferable prompt by distilling knowledge from multiple task-specific source prompts. Furthermore, multiplicative low rank updates to this shared prompt are learned to efficiently adapt it to each downstream target task, e.g., as would be appreciated by one skilled in the art after reading the present description. As a result, approaches herein are able to exploit the rich cross-task knowledge with prompt vectors in a multitask learning setting.

Accordingly, the AI module 213 and/or data storage array 214 preferably include a global signature index that has a number of data chunks which have each been applied to any desired number of encoding models. In some approaches, each of multiple encoding models may correspond to a different AI based implementation that is supported by the system. In other words, each encoding model may apply a different interpretation to a given data chunk in a way that is unique to the respective AI based implementation. In one example, language based RAG applications may correspond to each of the respective encoding models. In another example, each encoding model may correspond to a different LLM. The LLMs that may be supported by the system may include, but are in no way limited to, the T5 transformer model, the Bidirectional Encoder Representations from Transformers (BERT) language model, the ELECTRA language model, etc., or any other LLMs (e.g., language spaces) that would be apparent to one skilled in the art after reading the present description. It follows that each of the encoding models may be configured (e.g., based at least in part on the corresponding AI based implementation) to evaluate a particular language (e.g., human language, computer coding language, motion based communication, etc.), and/or a particular medium (e.g., text, images, videos, etc.), and/or a particular type of data (e.g., sensor data, answers generated by other AI based models, user data, application data, etc.) depending on the desired approach.

Each entry in the global signature index may be compared against vector information received from other locations. For example, a mean vector received from the edge node 206 may be compared against the entries in the global signature index and identify whether any matching entries exist in the global signature index. In some approaches, entries in the global signature index may be organized such that the distance between entries is inversely proportional to how similar the entries are, e.g., in order to reduce latency associated with identifying whether any known data chunks in the global signature index match incoming data chunks.

With continued reference to FIG. 2, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include any desired number and/or type of AI-based models. It follows that AI module 238 may implement similar, the same, or different characteristics as AI module 213 in central server 202.

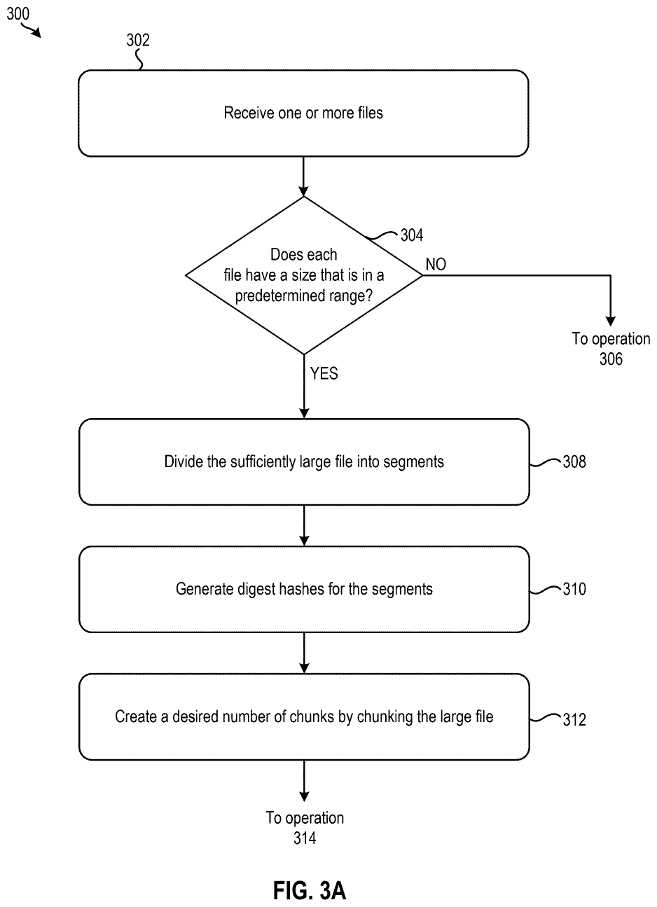

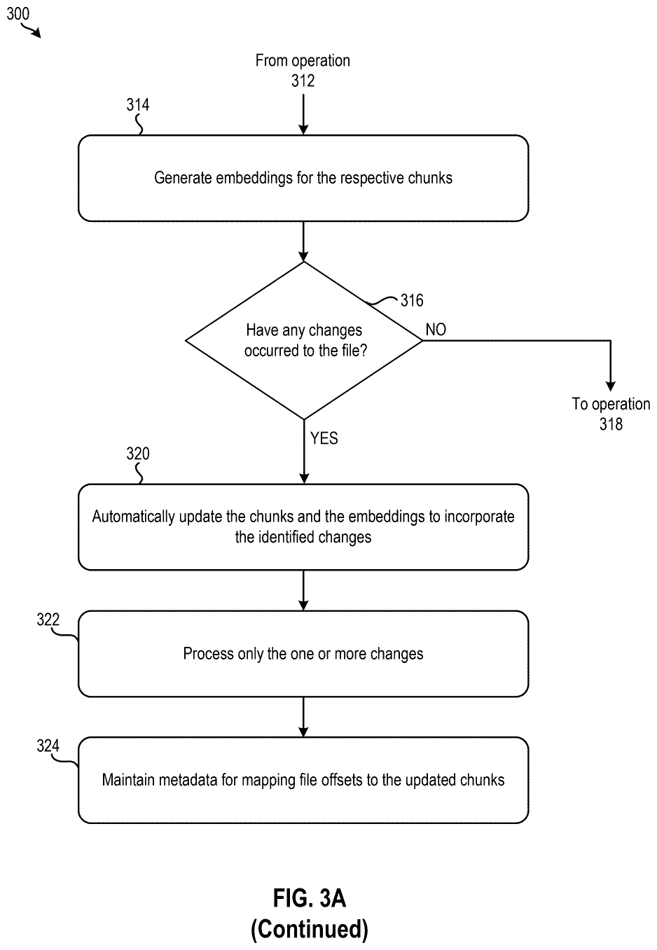

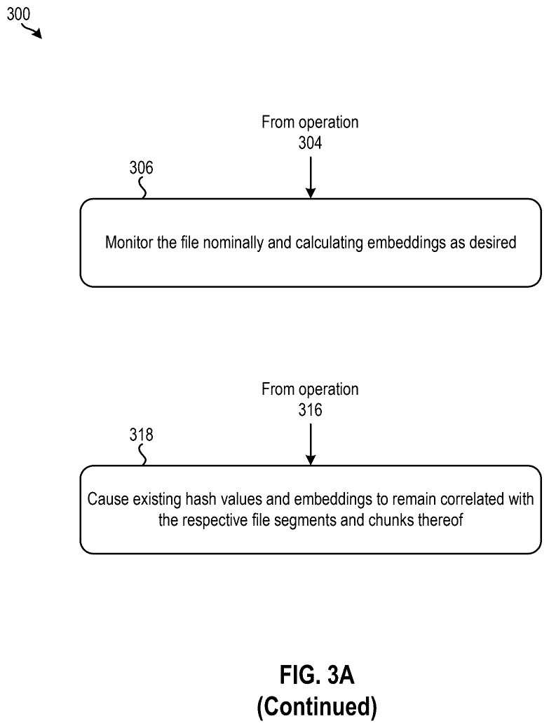

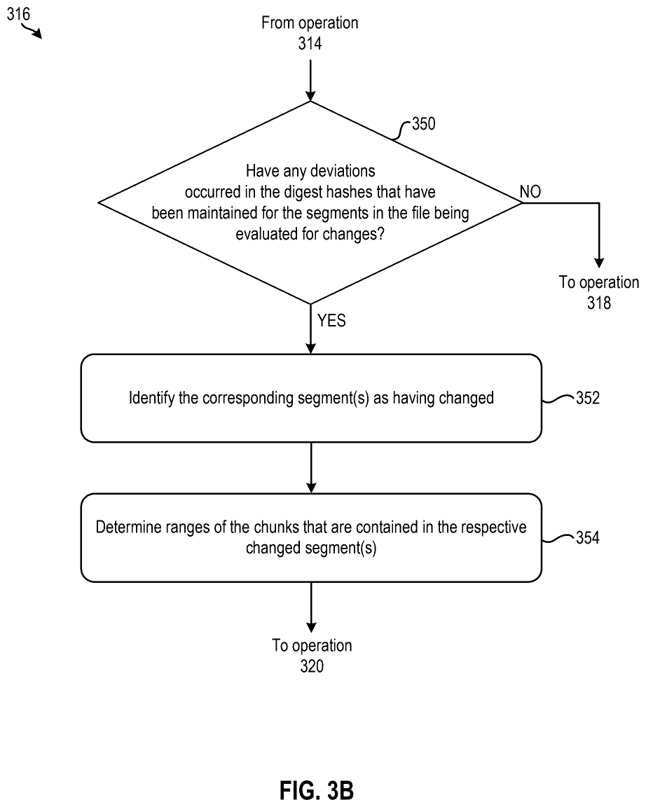

Looking now to FIG. 3A, a method 300 for improving the efficiency by which embeddings may be updated. Operations in method 300 may thereby involve eliminating duplicate calculations of embeddings for AI inferencing and training. This desirably allows for approaches herein to reduce latency as well as resource (e.g., compute) consumption, particularly for large files. For instance, only data that has been identified as being modified may result in new embeddings being calculated, while data that has only been moved or copied may reuse embeddings that have already been calculated, thereby reducing compute consumption and latency, e.g., as will be described in further detail below.

The method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment. For example, any one or more of the operations in method 300 may be performed by a controller and/or AI module at a central location (e.g., see processor 212 and/or AI module 213 of FIG. 2). In other approaches, the method 300 may be partially or entirely performed by a controller, a processor, a computer, etc., or some other device having one or more processors therein. Thus, in some approaches, method 300 may be a computer-implemented method. Moreover, the terms computer, processor and controller may be used interchangeably with regards to any of the approaches herein, such components being considered equivalents in the many various permutations of the present invention.

For those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes receiving a file or more than one file. The number of files that are received varies depending on factors, e.g., such as network traffic, running applications, real-time performance, user preferences, etc. The file(s) may be received from a number of different sources depending on the approach. For instance, files may be received from one or more of a user, a remote system, running applications, trained AI based models, etc. Additionally, the type(s) of file(s) that are received may vary depending on the approach. For instance, some of the received files may actually introduce new data to the storage system, while other received files may only involve known data that already exists in the storage system.

In response to receiving two or more files at the storage system in a predetermined amount of time, the files are preferably combined and evaluated together. For instance, the combined files are evaluated, and a determination is made as to whether the combined files are of a predetermined size.

From operation 302, method 300 advances to operation 304. There, operation 304 includes determining whether the file has a size that is in a predetermined range. In other words, operation 304 includes determining whether the file received in operation 302 has a size that is in a predetermined range. As noted above, improvements achieved by approaches herein are particularly apparent as the size of the abstraction (e.g., file) increases. In some approaches the benefits of implementing one or more of the remaining operations in method 300 may be weighed against the impact of not doing so. It should also be noted that in response to receiving two or more files at the storage system in a predetermined amount of time, the files may be combined and evaluated together. For instance, the combined files are evaluated, and a determination is made as to whether the combined files are of a predetermined size.

In situations where the size of the received file is not in the predetermined range, it may be determined that monitoring and implementing changes thereto may be performed nominally. In other words, files identified as being smaller than a threshold may have embeddings calculated as desired (e.g., regardless of whether change is present) for lack of substantial impact on the overall resource consumption. Thus, in response to determining that the file received in operation 302 is not in the predetermined range, method 300 advances from operation 304 to operation 306. There, operation 306 includes monitoring the file nominally and calculating embeddings as desired.

However, method 300 advances from operation 304 to operation 308 in response to determining that the size of the received file is in the predetermined range. Here, the received file may be sufficiently large to justify the additional pre-processing and/or evaluation associated with performing a more thorough evaluation of if and/or what has changed in a file over time. It follows that “large” as used herein may refer to a collection of data (e.g., a file) that has a logical and/or physical size that is in a predetermined range, above a predetermined threshold, and/or other equivalent determinations with respect to the amount of information that is stored therein. Accordingly, operation 308 includes dividing the sufficiently large file into segments. The number and/or size of the segments that are formed in operation 308 may vary depending on the approach. For instance, in some approaches the segments formed in operation 308 are preferably not so small that excessive metadata is generated, and not too large that unchanged data is continually re-processed. Operation 308 may thereby involve balancing the tradeoff between excess metadata and increased compute overhead.

From operation 308, method 300 advances to operation 310. There, operation 310 includes generating hashes (e.g., digests) for the segments. In other words, operation 310 includes computing hash values for each of the segments that were formed in operation 308. These hash values may be calculated using any processes which would be apparent to one skilled in the art after reading the present description and may be used to reconstruct the data over which the hash was computed. The hash values may also be stored in different forms depending on the desired approach. For instance, some approaches involve dividing large files into segments, generating hashes for each of the segments, and storing the hashes as metadata. It follows that in situations where a large file is written, corresponding hash values are preferably generated and used to form a foundation that provides insight into whether changes have occurred to the underlying file, e.g., as will be described in further detail below.

With continued reference to FIG. 3A, method 300 advances from operation 310 to operation 312. There, operation 312 includes creating a desired number of chunks by chunking the large file. In other words, operation 312 includes chunking the file determined in operation 304 as having a size that is in the predetermined range. Operation 312 may thereby include dividing each of the file segments further into a desired number of chunks. Chunk size may vary in a given file in some approaches. In other approaches, the chunks formed in operation 312 for a sufficiently large file may have the same or similar size as each other. However, it should be noted that the chunks preferably have a smaller respective size than the segments. In other words, each of the chunks are smaller than each of the respective segments, allowing each file segment to include more than one chunk therein.

Approaches herein are also able to improve storage capacity. For instance, space efficiency is increased by identifying chunks using references to their respective locations, e.g., rather than being copied to multiple locations. In other words, systems herein may implement data deduplication and/or other steps to further improve performance overall. According to an example, segments and/or chunks of a file may further be compressed to further improve storage capacity, e.g., as would be appreciated by one skilled in the art after reading the present description.

From operation 312, method 300 advances to operation 314. There, operation 314 includes generating embeddings for the respective chunks formed in operation 312. Operation 314 thereby includes computing embeddings for each of the chunks that are formed during the chunking process. This initial ingestion of the received file involves forming embeddings for each chunk (e.g., portion) of the file to develop a foundation that may be compared against the file over time to determine whether any changes have occurred thereto. Operation 314 provides insight that is used to determine whether changes have occurred to the underlying file, e.g., as will soon become apparent. Moreover, the embeddings may be calculated using any processes and/or procedures that would be apparent to one skilled in the art after reading the present description. The embeddings may also be stored differently depending on the desired approach. For example, while it may be preferred that at least some of the embeddings are stored in a vector database, this is in no way intended to be limiting. Moreover, the hashes may be stored as metadata. For example, one or more of the hash values may be converted into metadata and stored as a respective entry in a hash table, e.g., as would be appreciated by one skilled in the art after reading the present description.

From operation 314, method 300 advances to operation 316. There, operation 316 monitors the file and determines whether any changes have occurred thereto. Operation 316 may also involve monitoring other files that have previously been received and ingested by the system (e.g., components) that are performing method 300. As shown, method 300 advances from operation 316 to operation 318 in response to determining that no changes have occurred to the file. There, operation 318 includes causing existing hash values and embeddings to remain correlated with the respective file segments and chunks thereof. Again, by preventing (e.g., intentionally avoiding) re-computing embeddings and/or other related information for file segments or chunks that have not changed, approaches herein are able to significantly reduce compute overhead experienced by systems maintaining data therein.

However, method 300 alternatively advances from operation 316 to operation 320 in response to determining that one or more changes have occurred in the file. In other words, method 300 advances to operation 320 in response to identifying that one or more of the segments and/or chunks therein have been modified. There, operation 320 includes automatically updating the chunks and the embeddings to incorporate the identified changes. In other words, operation 320 includes recalculating hash values and/or embeddings only for segments and/or chunks in the file that have changed.

Referring momentarily to FIG. 3B, exemplary steps of determining whether the file (or other files previously ingested) has experienced any changes and how to respond are illustrated in accordance with one approach. It follows that one or more of these steps may be used to perform operation(s) 316 and/or 320 of FIG. 3A. However, it should be noted that the sub-operations of FIG. 3B are illustrated in accordance with one approach which is in no way intended to be limiting.

As shown, step 350 includes comparing the hashes for the segments to previous values. In other words, step 350 includes determining whether any deviations have occurred in the hashes that have been maintained for the segments in the file being evaluated for changes. Differences between hash values that have been determined for the same segment of a file over time may be used to indicate the presence of changes to the underlying file. Some approaches may thereby reference one or more hash tables. Comparing segments of the file in this manner allows for changes to be quickly identified in a broad area, after which a more detailed approach to locating the specific changes may be taken. Again, approaches herein are able to significantly reduce latency and compute overhead by identifying changes that occur in files over time, and only update records to reflect the identified changes.

The flowchart of FIG. 3B advances from step 350 to step 352 in response to determining that one or more of the hashes have changed from the previous values. In other words, the flowchart progresses to step 352 in response to determining that one or more changes have occurred in one or more of the file segments. There, step 352 includes identifying the corresponding segment(s) as having changed. Moreover, step 354 includes determining ranges of the chunks that are contained in the respective changed segment(s). In other words, steps 352 and 354 involve locating the specific portions of a file that have changed.

Chunks and/or segments that have been impacted over time may be identified differently depending on the approach. For instance, chunks that have a fixed size (referred to as “fixed size chunks”) may be identified simply by using the number of segments and their respective sizes. In such approaches having fixed size chunks, ranges of chunks that are contained in the respective changed segment(s) may be determined by multiplying corresponding segment number(s) by the respective segment size(s). This may identify a specific section of the originally received file that has undergone changes, e.g., which may result from one or more data write operations, data modify operations, data delete operations, etc.

For chunks that have a variable size (referred to as “variable size chunks”), ranges of the chunks that are contained in the respective changed segment may be identified differently. In such approaches having variable size chunks, ranges of the chunks in the respective changed segment(s) may be determined by using a tree indexed by byte offset to perform logarithmic time lookups. This effectively works to find the beginning or end of a chunk quickly. According to some examples, the time complexity of an algorithm is typically expressed as a function, e.g., constant, logarithmic, linear, exponential, etc. Approaches herein preferably implement at least a logarithmic algorithm, and more preferably constant time on average by using a hash table with few collisions. For approaches implementing logarithmic algorithms, a tree is a data structure, that sorts the data by some key, in this case the byte offset in the file of the chunk. A balanced tree is one where the number of levels is log “n” where there are n items in the tree. Traversing the tree to find something is counted by the number of levels to traverse before reaching the leaf. Hence, a logarithmic time operation. As noted above, this may identify a specific section of the originally received file that has undergone changes, e.g., which may result from one or more data write operations, data modify operations, data delete operations, etc.

It follows that in some approaches, changes to chunks and/or segments are found using metadata that maps file offsets to chunks, including partial chunks that overlap changed segment boundaries. Embeddings for changed and appended chunks may thereby be selectively generated, stored, and available for retrieval, e.g. as will soon become apparent. However, returning briefly to step 350, the flowchart alternatively advances to operation 318 of FIG. 3A in response to determining that none of the hashes have changed from the previous values. In other words, the flowchart progresses to FIG. 3A in response to determining that no changes have occurred in any of the file segments. As noted above, there operation 318 includes causing existing hash values and embeddings to remain correlated with the respective file segments and chunks thereof. Again, by preventing embeddings and/or other related information for file segments or chunks that have not changed from being re-computed, approaches herein are able to significantly reduce compute overhead experienced by systems maintaining data therein.

Returning now to FIG. 3A, method 300 may return to operation 316 from operation 318, e.g., such that files maintained in the system may continue to be monitored for changes. However, in some approaches method 300 may end in response to performing operation 318.

Looking back to operation 320, method 300 proceeds from there to operation 322 in response to updating the chunks and the embeddings to incorporate the identified changes. There, operation 322 includes processing only the one or more changes. In other words, the specific segments and/or chunks from the file that are identified in operation 320 as having changed are implemented in the system. For example, operation 322 may include recalculating hash values and/or embedding vectors that represent the segments and/or chunks identified as having changed. It follows that processing only the one or more changes in operation 322 includes preventing unchanged parts of the large file from being processed. In other words, operation 322 includes intentionally not (e.g., actively avoiding) re-processing unchanged parts (e.g., segments and/or chunks) of the large file being evaluated. Again, this desirably reduces latency and improves operational efficiency by significantly reducing computational overhead.

From operation 322, method further advances to operation 324. There, operation 324 includes maintaining metadata for mapping file offsets to the updated chunks. In other words, operation 324 includes updating the metadata to indicate the newly recalculated hash values and/or embeddings for segments and/or chunks in the file that have changed. Operation 324 may include updating metadata tables, hash tables, vector databases, etc. to indicate the changes that have occurred to the file and/or portions thereof. This allows for the updated metadata to be available for comparison moving forward to determine whether any additional changes occur.

Again, approaches herein are desirably able to automatically respond to file changes by updating chunks and embeddings only for the portions of the file that did change. As described above, this desirably reduces latency and resource consumption by reducing the number of computations that occur on an ongoing basis. Specifically, approaches herein process only parts of a file that are determined as having changed, and preventing parts of the file that remain unchanged from being re-processed. Furthermore, by maintaining metadata for mapping file offsets to chunks, approaches herein are able to maintain a strong correlation between known information.

According now to an in-use example, which is in no way intended to be limiting, chunk management may be optimized for situations where some (or none) of a sufficiently large file is rewritten, append to, shrunk, etc. For instance, data may be changed in the beginning or middle of a file where the changed section size is unchanged, same data may be rewritten to the same location, data may be added to the end, data may be removed from the end, etc. In the present in-use example, suppose file A has the following chunk and segment tables:

CHUNK TABLE

| Byte | Chunk |
|---|---|
| offset | number |
| 0 | 0 |
| 54 | 1 |
| 102 | 2 |
| 179 | 3 |
| 330 | 4 |
| 450 | 5 |

SEGMENT TABLE

| | Byte | |
|---|---|---|
| Segment | offset | Digest |
| 0 | 0 | 8828 |
| 1 | 100 | 7451 |
| 2 | 350 | 9006 |

In the present in-use example, bytes 250-295 may be overwritten with new values. This typically results in a notification that the file has changed. Moreover, in order to identify the segments that have changed, the segment digests (e.g., hashes) are recomputed and changed segments are identified. By comparing the digest of each segment to its respective old value, approaches herein are able to determine that only Segment 1 has changed because its new and old digests differ.

The range of chunks contained in the changed segment ranges are further identified. A chunk table determines which chunks are on the borders of the segment range. For fixed-sized chunks, byte offsets are determined in constant time by multiplying segment number by segment size. For variable size chunks, a tree indexed by byte offset is employed for logarithmic time lookups.

In the present in-use example, segment 1 begins at byte 100 and ends at byte 349. The boundary offsets are looked up in the chunk table which says byte 100 maps to chunk 2 and byte 349 maps to chunk 4. The range of affected chunks is 2-4. The affected byte range, 100-349, is optionally rechunked and embeddings are regenerated for the rechunked byte range. The chunk table may further be updated to reflect any relevant information, old embeddings are removed, and new embeddings are stored. According to some approaches, embeddings are stored in a vector database. Thus, a fast approximate nearest neighbor semantic search may be conducted on the embeddings.

In an alternative approach, an algorithm may be integrated into a filesystem such that segments can be omitted but byte-to-chunk mapping remains. In such approaches, digests are typically not stored, but rather calculated on-the-fly prior to a byte range being updated. The affected byte ranges may thereby be mapped directly to chunk ranges to reprocess. As noted above, conventional products are unable to identify specific portions (e.g., byte ranges) of a file that have changed. In sharp contrast, some approaches herein update notification interfaces to include byte ranges. However, some approaches may track changes in the filesystem which is a layer lower. Accordingly, changes to a large file may be determined without using the hashes. The underlying filesystem updates the byte ranges that have been requested by a user. Those byte range update events trigger the embedding updates for the chunks touching the updated byte range. By implementing the approaches herein in the file system layer, hashes are not involved in the process of detecting changes. Rather, they are simply triggered on write events. Additionally, in approaches where the same data is rewritten, the old version of a block is read and compared byte-by-byte to the new one before it is replaced rather than managing a hash to detect changes. In response to determining there is no difference between them, the embedding update may be skipped.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

1. A method comprising:
dividing a large file into segments;
generating hashes for the segments;
creating a desired number of chunks by chunking the large file;
generating embeddings for the created chunks;
determining whether one or more changes have occurred to the large file by:
comparing the hashes for the segments to previous values, and
in response to determining one or more of the hashes have changed from the previous values:
identifying corresponding segments as having changed, and
determining ranges of the created chunks that are contained within the corresponding segments identified as having changed; and
in response to determining one or more changes have occurred to the large file:
automatically updating the created chunks and the embeddings,
processing only the one or more changes, and
maintaining metadata for mapping file offsets to the updated chunks.

2. (canceled)

3. The method of claim 1, wherein:
the determining ranges of the created chunks includes multiplying corresponding segment number(s) by respective segment size(s).

4. The method of claim 1, wherein:
the determining ranges of the created chunks includes using a tree indexed by byte offset to perform logarithmic time lookups.

5. The method of claim 1, wherein the processing only the one or more changes includes preventing unchanged parts of the large file from being processed.

6. The method of claim 1, wherein the embeddings are stored in a vector database, and the hashes are stored as metadata.

7. The method of claim 1, wherein the one or more changes to the large file are determined without the hashes.

8. The method of claim 1, wherein the created chunks have a smaller respective size than the corresponding segments.

9. A computer program product comprising:
one or more non-transitory computer-readable storage media; and
program instructions stored on the one or more non-transitory computer-readable storage media to perform operations comprising:
dividing a large file into segments;
generating hashes for the segments;
creating a desired number of chunks by chunking the large file;
generating embeddings for the created chunks;
determining whether one or more changes have occurred to the large file by:
comparing the hashes for the segments to previous values, and
in response to determining one or more of the hashes have changed from the previous values:
identifying corresponding segments as having changed, and
determining ranges of the created chunks that are contained within the corresponding segments identified as having changed; and
in response to determining one or more changes have occurred to the large file:
automatically updating the created chunks and the embeddings,
processing only the one or more changes, and
maintaining metadata for mapping file offsets to the updated chunks.

10. (canceled)

11. The computer program product of claim 2, wherein:
the determining ranges of the created chunks includes multiplying corresponding segment number(s) by respective segment size(s).

12. The computer program product of claim 9, wherein:
determining ranges of the created chunks includes using a tree indexed by byte offset to perform logarithmic time lookups.

13. The computer program product of claim 9, wherein the processing only the one or more changes includes preventing unchanged parts of the large file from being processed.

14. The computer program product of claim 9, wherein the embeddings are stored in a vector database, and the hashes are stored as metadata.

15. The computer program product of claim 9, wherein the one or more changes to the large file are determined without the hashes.

16. The computer program product of claim 9, wherein the created chunks have a smaller respective size than the corresponding segments.

17. A computer system comprising:
a processor set;
one or more computer-readable storage media; and
program instructions stored on the one or more computer-readable storage media to cause the processor set to perform operations comprising:
dividing a large file into segments;
generating hashes for the segments;
creating a desired number of chunks by chunking the large file;
generating embeddings for the created chunks;
determining whether one or more changes have occurred to the large file by:
comparing the hashes for the segments to previous values, and
in response to determining one or more of the hashes have changed from the previous values:
identifying corresponding segments as having changed, and
determining ranges of the created chunks that are contained within the corresponding segments identified as having changed; and
in response to determining one or more changes have occurred to the large file:
automatically updating the created chunks and the embeddings,
processing only the one or more changes, and
maintaining metadata for mapping file offsets to the updated chunks.

18. (canceled)

19. The computer system of claim 17, wherein:
the determining ranges of the created chunks includes multiplying corresponding segment number(s) by respective segment size(s).

20. The computer system of claim 17, wherein:
the determining ranges of the created chunks includes using a tree indexed by byte offset to perform logarithmic time lookups.

21. The computer system of claim 17, wherein the processing only the one or more changes includes preventing unchanged parts of the large file from being processed.

22. The computer system of claim 17, wherein the embeddings are stored in a vector database, and the hashes are stored as metadata.

23. The computer system of claim 17, wherein the one or more changes to the large file are determined without the hashes.
